(19) United States
(12) Patent Application Publication
(10) Pub. No.: US 2023/0396313 A1
(43) Pub. Date: Dec. 7, 2023

(54) INTERFERENCE MANAGEMENT SCHEMES IN MULTICAST BROADCAST SERVICE IN A WIRELESS NETWORK

(71) Applicant: Parsa Wireless Communications LLC, Stamford, CT (US)

(72) Inventor: Reza Kalbasi, San Diego, CA (US)

(73) Assignee: Parsa Wireless Communications LLC, Stamford, CT (US)

(21) Appl. No.: 18/329,181

(22) Filed: Jun. 5, 2023

Related U.S. Application Data
(60) Provisional application No. 63/349,254, filed on Jun. 6, 2022.

(51) Int. Cl. H04B 7/08; H04B 17/318; H04B 7/0404; H04W 4/06

(52) U.S. Cl. CPC H04B 7/088; H04B 17/328; H04B 7/0404; H04W 4/06

(57) ABSTRACT

Apparatus and methods for interference management in Multicast Broadcast Service (MBS) in a wireless network. A User Equipment (UE) receives unicast and MBS from a Base Station (BS). In one embodiment, the UE measures the interference between unicast and MBS, and performs beam adaptation to find a receive beam that matches both unicast and MBS beams to reduce the interference between the unicast and MBS. In another embodiment, the UE reports its desired receive beam direction to the BS. The BS may schedule the UE with the indicated beam by the UE. In other embodiment, the BS measures the link qualities of a plurality of the UEs receiving MBS, and if it receives a link failure indication from a UE, it may schedule that UE with a unicast service.

### CROSS-REFERENCE TO RELATED APPLICATION

This application claims priority under 35 USC § 119(e) from U.S. Provisional Patent Application No. 63/349,254, filed on Jun. 6, 2022 (“the provisional application”); the content of the provisional patent application is incorporated herein by reference.

### BACKGROUND OF THE INVENTION

The present invention is directed to 5G, which is the 5^{th} generation mobile network. It is a new global wireless standard after 1G, 2G, 3G, and 4G networks. 5G enables networks designed to connect machines, objects and devices.

The invention is more specifically directed to apparatus and methods for interference management in Multicast Broadcast Service (MBS) in a wireless network.

### SUMMARY OF THE INVENTION

In an embodiment, the invention provides a method of beam adaptation at a user equipment (UE) that includes receiving, from a base station (BS), Downlink (DL) signals in a wide beam; receiving, from the base station (BS), the Downlink (DL) signals in a narrow beam; measuring the wide beam signal strength; measuring the narrow beam signal strength; determining a receive beam direction that can be a best match to both the wide beam and the narrow beam; and adapting receive beam to the determined receive beam direction. Preferably, the wide beam indicates a Multicast Broadcast Service (MBS) transmission from the BS to a plurality of UEs. The narrow beam may indicate a unicast service transmission from the BS to the UE. The determining the receive beam direction may include: changing the receive beam direction to a new beam direction; and measuring received signal strength from the BS in both the wide beam and the narrow beam.

The inventive method also may include measuring a plurality of Downlink (DLs) beams transmitted from the BS; and reporting the best beam direction in the plurality of DL beams that can be a match to the wide beam and the narrow beam to the BS. The method can include measuring the wide beam signal strength or the narrow beam signal strength includes measuring Reference Signal Received Power (RSRP) and Reference Signal Received Quality (RSRQ) of the narrow beam or the wide beam. The method may further include receiving, from the BS, the DL signals in the best beam direction reported by the UE.

In an embodiment, the method of interference management at a Base Station (BS) includes transmitting, to a first user equipment (UE), downlink (DL) signals in a narrow beam in a first direction; transmitting, to a plurality UEs, Downlink (DL) signals in a wide beam; receiving, from the first UE, an Uplink signal indicating DL interference between the wide beam and the narrow beam; and in response to receiving the UL signal, determining a second direction to transmit DL signals to the first UE. The wide beam may indicate a Multicast Broadcast Service (MBS) transmitted from the BS to a plurality of UEs. The narrow beam indicates a unicast service transmitted from the BS to the first UE. Determining the second direction may include includes determining the second direction such as transmitting the DL signals in the second direction reduces the interference of the wide beam over the narrow beam.

In an embodiment, the invention includes a method of beam management at a Base Station (BS), including transmitting, to a plurality UEs, Downlink (DL) signals in a wide beam; receiving, from each of the plurality of UEs, reports indicating link quality between the BS and the each of the plurality of UEs; and transmitting DL signals to UEs in the plurality of UEs in narrow beams wherein their links qualities are lower than the link quality required for DL signals reception. The wide beam may indicate a Multicast Broadcast Service (MBS) transmitted from the BS to the plurality of UEs. The step of transmitting DL signals to the UEs in the plurality of UEs in the narrow beams wherein their links qualities are lower than the link quality required for DL signals reception may include transmitting DL signals to the UEs in unicast services.

In an embodiment, the invention provides a user equipment (UE) that includes a transceiver configured to: receive, from a base station (BS), Downlink (DL) signals in a wide beam; receive, from the base station (BS), the Downlink (DL) signals in a narrow beam; measure the wide beam signal strength; and measure the narrow beam signal strength; and a processor in communication with the transceiver and configured to: determine a receive beam direction that can be a best match to both the wide beam and the narrow beam; and adapt receive beam to the determined receive beam direction. The transceiver may be further configured to receive Multicast Broadcast Service (MBS) from the BS in the wide beam. The transceiver may be further configured to receive unicast service from the BS in the narrow beam. The processor may be further configured to: change the receive beam to a new beam direction; and measure received signal strength from the BS in both the wide beam and the narrow beam. The processor may be further configured to: measure a plurality of Downlink (DLs) beams transmitted from the BS; and report a best beam direction in the plurality of DL beams that can be a match to the wide beam and the narrow beam to the BS. The processor may be further configured to: receive from the BS, the DL signals in the best beam direction reported by the UE.

### BRIEF DESCRIPTION OF THE DRAWINGS

FIG. 1 shows an example of a system of mobile communications according to some aspects of some of various exemplary embodiments of the present disclosure.

FIG. 2A and FIG. 2B show examples of radio protocol stacks for user plane and control plane, respectively, according to some aspects of some of various exemplary embodiments of the present disclosure.

FIG. 3A, FIG. 3B and FIG. 3C show example mappings between logical channels and transport channels in downlink, uplink and sidelink, respectively, according to some aspects of some of various exemplary embodiments of the present disclosure.

FIG. 4A, FIG. 4B and FIG. 4C show example mappings between transport channels and physical channels in downlink, uplink and sidelink, respectively, according to some aspects of some of various exemplary embodiments of the present disclosure.

FIG. 5A, FIG. 5B, FIG. 5C and FIG. 5D show examples of radio protocol stacks for NR sidelink communication according to some aspects of some of various exemplary embodiments of the present disclosure.

FIG. 6 shows example physical signals in downlink, uplink and sidelink according to some aspects of some of various exemplary embodiments of the present disclosure.

FIG. 7 shows examples of Radio Resource Control (RRC) states and transitioning between different RRC states according to some aspects of some of various exemplary embodiments of the present disclosure.

FIG. 8 shows example frame structure and physical resources according to some aspects of some of various exemplary embodiments of the present disclosure.

FIG. 9 shows an example of UE performing beam management scheme while receiving simultaneously unicast service and Multicast Broadcast Service (MBS) according to some aspects of some of various exemplary embodiments of the present disclosure.

FIG. 10 shows an example of a system performing interference management scheme in scenarios with simultaneous unicast service and MBS according to some aspects of some of various exemplary embodiments of the present disclosure.

FIG. 11 shows an example of a system performing beam management scheme in MBS according to some aspects of some of various exemplary embodiments of the present disclosure.

FIG. 12 shows an exemplary block diagram of a User Equipment (UE) device according to some aspects of some of various exemplary embodiments of the present disclosure.

FIG. 13 shows an exemplary block diagram of a base station according to some aspects of some of various exemplary embodiments of the present disclosure.

FIG. 14 is a flow diagram of a method of beam management at UE receiving both unicast and MBS according to some aspects of some of various exemplary embodiments of the present disclosure.

FIG. 15 is a flow diagram of a method of interreference management at a base station transmitting both unicast and MBS according to some aspects of some of various exemplary embodiments of the present disclosure.

FIG. 16 is a flow diagram of a method of beam management at a base station transmitting MBS according to some aspects of some of various exemplary embodiments of the present disclosure.

### DETAILED DESCRIPTION OF THE INVENTION

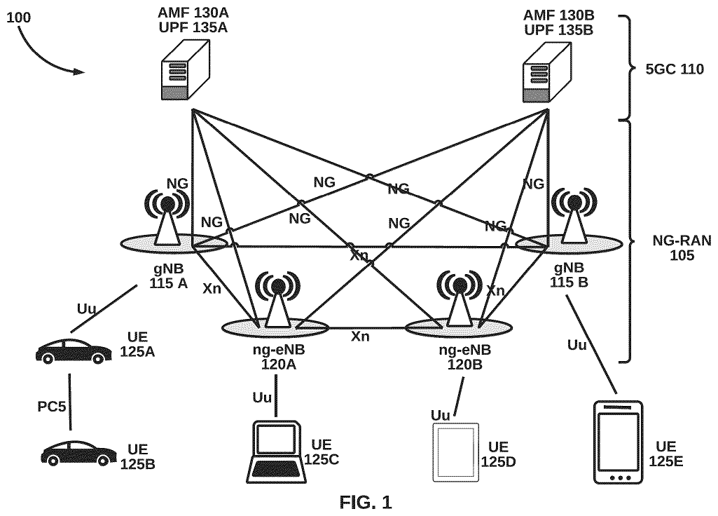

FIG. 1 shows an example of a system of mobile communications 100 according to some aspects of some of various exemplary embodiments of the present disclosure. The system of mobile communication 100 may be operated by a wireless communications system operator such as a Mobile Network Operator (MNO), a private network operator, a Multiple System Operator (MSO), an Internet of Things (IOT) network operator, etc., and may offer services such as voice, data (e.g., wireless Internet access), messaging, vehicular communications services such as Vehicle to Everything (V2X) communications services, safety services, mission critical service, services in residential, commercial or industrial settings such as IoT, industrial IOT (IIOT), etc.

The system of mobile communications 100 may enable various types of applications with different requirements in terms of latency, reliability, throughput, etc. Example supported applications include enhanced Mobile Broadband (eMBB), Ultra-Reliable Low-Latency Communications (URLLC), and massive Machine Type Communications (mMTC). eMBB may support stable connections with high peak data rates, as well as moderate rates for cell-edge users. URLLC may support applications with strict requirements in terms of latency and reliability and moderate requirements in terms of data rate. Example mMTC application includes a network of a massive number of IoT devices, which are only sporadically active and send small data payloads.

The system of mobile communications 100 may include a Radio Access Network (RAN) portion and a core network portion. The example shown in FIG. 1 illustrates a Next Generation RAN (NG-RAN) 105 and a 5G Core Network (5GC) 110 as examples of the RAN and core network, respectively. Other examples of RAN and core network may be implemented without departing from the scope of this disclosure. Other examples of RAN include Evolved Universal Terrestrial Radio Access Network (EUTRAN), Universal Terrestrial Radio Access Network (UTRAN), etc. Other examples of core network include Evolved Packet Core (EPC), UMTS Core Network (UCN), etc. The RAN implements a Radio Access Technology (RAT) and resides between User Equipments (UEs) 125 and the core network. Examples of such RATs include New Radio (NR), Long Term Evolution (LTE) also known as Evolved Universal Terrestrial Radio Access (EUTRA), Universal Mobile Telecommunication System (UMTS), etc. The RAT of the example system of mobile communications 100 may be NR. The core network resides between the RAN and one or more external networks (e.g., data networks) and is responsible for functions such as mobility management, authentication, session management, setting up bearers and application of different Quality of Services (QoSs). The functional layer between the UE 125 and the RAN (e.g., the NG-RAN 105) may be referred to as Access Stratum (AS) and the functional layer between the UE 125 and the core network (e.g., the 5GC 110) may be referred to as Non-access Stratum (NAS).

The UEs 125 may include wireless transmission and reception means for communications with one or more nodes in the RAN, one or more relay nodes, or one or more other UEs, etc. Examples of UEs include, but are not limited to, smartphones, tablets, laptops, computers, wireless transmission and/or reception units in a vehicle, V2X or Vehicle to Vehicle (V2V) devices, wireless sensors, IoT devices, HOT devices, etc. Other names may be used for UEs such as a Mobile Station (MS), terminal equipment, terminal node, client device, mobile device, etc.

The RAN may include nodes (e.g., base stations) for communications with the UEs. For example, the NG-RAN 105 of the system of mobile communications 100 may comprise nodes for communications with the UEs 125. Different names for the RAN nodes may be used, for example depending on the RAT used for the RAN. A RAN node may be referred to as Node B (NB) in a RAN that uses the UMTS RAT. A RAN node may be referred to as an evolved Node B (eNB) in a RAN that uses LTE/EUTRA RAT. For the illustrative example of the system of mobile communications 100 in FIG. 1, the nodes of an NG-RAN 105 may be either a next generation Node B (gNB) 115 or a next generation evolved Node B (ng-eNB) 120. In this specification, the terms base station, RAN node, gNB and ng-eNB may be used interchangeably. The gNB 115 may provide NR user plane and control plane protocol terminations towards the UE 125. The ng-eNB 120 may provide E-UTRA user plane and control plane protocol terminations towards the UE 125. An interface between the gNB 115 and the UE 125 or between the ng-eNB 120 and the UE 125 may be referred to as a Uu interface. The Uu interface may be established with a user plane protocol stack and a control plane protocol stack. For a Uu interface, the direction from the base station (e.g., the gNB 115 or the ng-eNB 120) to the UE 125 may be referred to as downlink and the direction from the UE 125 to the base station (e.g., gNB 115 or ng-eNB 120) may be referred to as uplink.

The gNBs 115 and ng-eNBs 120 may be interconnected with each other by means of an Xn interface. The Xn interface may comprise an Xn User plane (Xn-U) interface and an Xn Control plane (Xn-C) interface. The transport network layer of the Xn-U interface may be built on Internet Protocol (IP) transport and GPRS Tunneling Protocol (GTP) may be used on top of User Datagram Protocol (UDP)/IP to carry the user plane protocol data units (PDUs). Xn-U may provide non-guaranteed delivery of user plane PDUs and may support data forwarding and flow control. The transport network layer of the Xn-C interface may be built on Stream Control Transport Protocol (SCTP) on top of IP. The application layer signaling protocol may be referred to as XnAP (Xn Application Protocol). The SCTP layer may provide the guaranteed delivery of application layer messages. In the transport IP layer, point-to-point transmission may be used to deliver the signaling PDUs. The Xn-C interface may support Xn interface management, UE mobility management, including context transfer and RAN paging, and dual connectivity.

The gNBs 115 and ng-eNBs 120 may also be connected to the 5GC 110 by means of the NG interfaces, more specifically to an Access and Mobility Management Function (AMF) 130 of the 5GC 110 by means of the NG-C interface and to a User Plane Function (UPF) 135 of the 5GC 110 by means of the NG-U interface. The transport network layer of the NG-U interface may be built on IP transport and GTP protocol may be used on top of UDP/IP to carry the user plane PDUs between the NG-RAN node (e.g., gNB 115 or ng-eNB 120) and the UPF 135. NG-U may provide non-guaranteed delivery of user plane PDUs between the NG-RAN node and the UPF. The transport network layer of the NG-C interface may be built on IP transport. For the reliable transport of signaling messages, SCTP may be added on top of IP. The application layer signaling protocol may be referred to as NGAP (NG Application Protocol). The SCTP layer may provide guaranteed delivery of application layer messages. In the transport, IP layer point-to-point transmission may be used to deliver the signaling PDUs. The NG-C interface may provide the following functions: NG interface management; UE context management; UE mobility management; transport of NAS messages; paging; PDU Session Management; configuration transfer; and warning message transmission.

The gNB 115 or the ng-eNB 120 may host one or more of the following functions: Radio Resource Management functions such as Radio Bearer Control, Radio Admission Control, Connection Mobility Control, Dynamic allocation of resources to UEs in both uplink and downlink (e.g., scheduling); IP and Ethernet header compression, encryption and integrity protection of data; Selection of an AMF at UE attachment when no routing to an AMF can be determined from the information provided by the UE; Routing of User Plane data towards UPF(s); Routing of Control Plane information towards AMF; Connection setup and release; Scheduling and transmission of paging messages; Scheduling and transmission of system broadcast information (e.g., originated from the AMF); Measurement and measurement reporting configuration for mobility and scheduling; Transport level packet marking in the uplink; Session Management; Support of Network Slicing; QoS Flow management and mapping to data radio bearers; Support of UEs in RRC Inactive state; Distribution function for NAS messages; Radio access network sharing; Dual Connectivity; Tight interworking between NR and E-UTRA; and Maintaining security and radio configuration for User Plane 5G system (5GS) Cellular IoT (CIoT) Optimization.

The AMF 130 may host one or more of the following functions: NAS signaling termination; NAS signaling security; AS Security control; Inter CN node signaling for mobility between 3GPP access networks; Idle mode UE Reachability (including control and execution of paging retransmission); Registration Area management; Support of intra-system and inter-system mobility; Access Authentication; Access Authorization including check of roaming rights; Mobility management control (subscription and policies); Support of Network Slicing; Session Management Function (SMF) selection; Selection of 5GS CIoT optimizations.

The UPF 135 may host one or more of the following functions: Anchor point for Intra-/Inter-RAT mobility (when applicable); External PDU session point of interconnect to Data Network; Packet routing & forwarding; Packet inspection and User plane part of Policy rule enforcement; Traffic usage reporting; Uplink classifier to support routing traffic flows to a data network; Branching point to support multi-homed PDU session; QoS handling for user plane, e.g. packet filtering, gating, UL/DL rate enforcement; Uplink Traffic verification (Service Data Flow (SDF) to QoS flow mapping); Downlink packet buffering and downlink data notification triggering.

As shown in FIG. 1, the NG-RAN 105 may support the PC5 interface between two UEs 125 (e.g., UE 125A and UE 125B). In the PC5 interface, the direction of communications between two UEs (e.g., from UE 125A to UE 125B or vice versa) may be referred to as sidelink. Sidelink transmission and reception over the PC5 interface may be supported when the UE 125 is inside NG-RAN 105 coverage, irrespective of which RRC state the UE is in, and when the UE 125 is outside NG-RAN 105 coverage. Support of V2X services via the PC5 interface may be provided by NR sidelink communication and/or V2X sidelink communication.

PC5-S signaling may be used for unicast link establishment with Direct Communication Request/Accept message. A UE may self-assign its source Layer-2 ID for the PC5 unicast link for example based on the V2X service type. During unicast link establishment procedure, the UE may send its source Layer-2 ID for the PC5 unicast link to the peer UE, e.g., the UE for which a destination ID has been received from the upper layers. A pair of source Layer-2 ID and destination Layer-2 ID may uniquely identify a unicast link. The receiving UE may verify that the said destination ID belongs to it and may accept the Unicast link establishment request from the source UE. During the PC5 unicast link establishment procedure, a PC5-RRC procedure on the Access Stratum may be invoked for the purpose of UE sidelink context establishment as well as for AS layer configurations, capability exchange etc. PC5-RRC signaling may enable exchanging UE capabilities and AS layer configurations such as Sidelink Radio Bearer configurations between pair of UEs for which a PC5 unicast link is established.

NR sidelink communication may support one of three types of transmission modes (e.g., Unicast transmission, Groupcast transmission, and Broadcast transmission) for a pair of a Source Layer-2 ID and a Destination Layer-2 ID in the AS. The Unicast transmission mode may be characterized by: Support of one PC5-RRC connection between peer UEs for the pair; Transmission and reception of control information and user traffic between peer UEs in sidelink; Support of sidelink HARQ feedback; Support of sidelink transmit power control; Support of RLC Acknowledged Mode (AM); and Detection of radio link failure for the PC5-RRC connection. The Groupcast transmission may be characterized by: Transmission and reception of user traffic among UEs belonging to a group in sidelink; and Support of sidelink HARQ feedback. The Broadcast transmission may be characterized by: Transmission and reception of user traffic among UEs in sidelink.

A Source Layer-2 ID, a Destination Layer-2 ID and a PC5 Link Identifier may be used for NR sidelink communication. The Source Layer-2 ID may be a link-layer identity that identifies a device or a group of devices that are recipients of sidelink communication frames. The Destination Layer-2 ID may be a link-layer identity that identifies a device that originates sidelink communication frames. In some examples, the Source Layer-2 ID and the Destination Layer-2 ID may be assigned by a management function in the Core Network. The Source Layer-2 ID may identify the sender of the data in NR sidelink communication. The Source Layer-2 ID may be 24 bits long and may be split in the MAC layer into two bit strings: One bit string may be the LSB part (8 bits) of Source Layer-2 ID and forwarded to physical layer of the sender. This may identify the source of the intended data in sidelink control information and may be used for filtering of packets at the physical layer of the receiver; and the Second bit string may be the MSB part (16 bits) of the Source Layer-2 ID and may be carried within the Medium Access Control (MAC) header. This may be used for filtering packets at the MAC layer of the receiver. The Destination Layer-2 ID may identify the target of the data in NR sidelink communication. For NR sidelink communication, the Destination Layer-2 ID may be 24 bits long and may be split in the MAC layer into two bit strings: One bit string may be the LSB part (16 bits) of Destination Layer-2 ID and forwarded to physical layer of the sender. This may identify the target of the intended data in sidelink control information and may be used for filtering of packets at the physical layer of the receiver; and the Second bit string may be the MSB part (8 bits) of the Destination Layer-2 ID and may be carried within the MAC header. This may be used for filtering packets at the MAC layer of the receiver. The PC5 Link Identifier may uniquely identify the PC5 unicast link in a UE for the lifetime of the PC5 unicast link. The PC5 Link Identifier may be used to indicate the PC5 unicast link whose sidelink Radio Link failure (RLF) declaration was made and PC5-RRC connection was released.

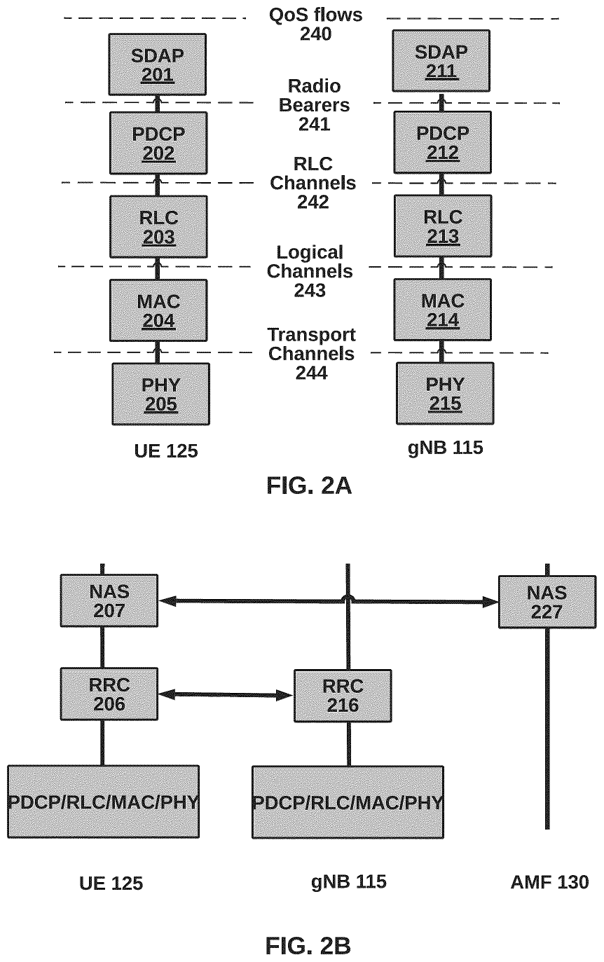

FIG. 2A and FIG. 2B show examples of radio protocol stacks for user plane and control plane, respectively, according to some aspects of some of various exemplary embodiments of the present disclosure. As shown in FIG. 2A, the protocol stack for the user plane of the Uu interface (between the UE 125 and the gNB 115) includes Service Data Adaptation Protocol (SDAP) 201 and SDAP 211, Packet Data Convergence Protocol (PDCP) 202 and PDCP 212, Radio Link Control (RLC) 203 and RLC 213, MAC 204 and MAC 214 sublayers of layer 2 and Physical (PHY) 205 and PHY 215 layer (layer 1 also referred to as L1).

The PHY 205 and PHY 215 offer transport channels 244 to the MAC 204 and MAC 214 sublayer. The MAC 204 and MAC 214 sublayer offer logical channels 243 to the RLC 203 and RLC 213 sublayer. The RLC 203 and RLC 213 sublayer offer RLC channels 242 to the PDCP 202 and PCP 212 sublayer. The PDCP 202 and PDCP 212 sublayer offer radio bearers 241 to the SDAP 201 and SDAP 211 sublayer. Radio bearers may be categorized into two groups: Data Radio Bearers (DRBs) for user plane data and Signaling Radio Bearers (SRBs) for control plane data. The SDAP 201 and SDAP 211 sublayer offers QoS flows 240 to 5GC.

The main services and functions of the MAC 204 or MAC 214 sublayer include: mapping between logical channels and transport channels; Multiplexing/demultiplexing of MAC Service Data Units (SDUs) belonging to one or different logical channels into/from Transport Blocks (TB) delivered to/from the physical layer on transport channels; Scheduling information reporting; Error correction through Hybrid Automatic Repeat Request (HARQ) (one HARQ entity per cell in case of carrier aggregation (CA)); Priority handling between UEs by means of dynamic scheduling; Priority handling between logical channels of one UE by means of Logical Channel Prioritization (LCP); Priority handling between overlapping resources of one UE; and Padding. A single MAC entity may support multiple numerologies, transmission timings and cells. Mapping restrictions in logical channel prioritization control which numerology(ies), cell(s), and transmission timing(s) a logical channel may use.

The HARQ functionality may ensure delivery between peer entities at Layer 1. A single HARQ process may support one TB when the physical layer is not configured for downlink/uplink spatial multiplexing, and when the physical layer is configured for downlink/uplink spatial multiplexing, a single HARQ process may support one or multiple TBs.

The RLC 203 or RLC 213 sublayer may support three transmission modes: Transparent Mode (TM); Unacknowledged Mode (UM); and Acknowledged Mode (AM). The RLC configuration may be per logical channel with no dependency on numerologies and/or transmission durations, and Automatic Repeat Request (ARQ) may operate on any of the numerologies and/or transmission durations the logical channel is configured with.

The main services and functions of the RLC 203 or RLC 213 sublayer depend on the transmission mode (e.g., TM, UM or AM) and may include: Transfer of upper layer PDUs; Sequence numbering independent of the one in PDCP (UM and AM); Error Correction through ARQ (AM only); Segmentation (AM and UM) and re-segmentation (AM only) of RLC SDUs; Reassembly of SDU (AM and UM); Duplicate Detection (AM only); RLC SDU discard (AM and UM); RLC re-establishment; and Protocol error detection (AM only).

The automatic repeat request within the RLC 203 or RLC 213 sublayer may have the following characteristics: ARQ retransmits RLC SDUs or RLC SDU segments based on RLC status reports; Polling for RLC status report may be used when needed by RLC; RLC receiver may also trigger RLC status report after detecting a missing RLC SDU or RLC SDU segment.

The main services and functions of the PDCP 202 or PDCP 212 sublayer may include: Transfer of data (user plane or control plane); Maintenance of PDCP Sequence Numbers (SNs); Header compression and decompression using the Robust Header Compression (ROHC) protocol; Header compression and decompression using EHC protocol; Ciphering and deciphering; Integrity protection and integrity verification; Timer based SDU discard; Routing for split bearers; Duplication; Reordering and in-order delivery; Out-of-order delivery; and Duplicate discarding.

The main services and functions of SDAP 201 or SDAP 211 include: Mapping between a QoS flow and a data radio bearer; and Marking QoS Flow ID (QFI) in both downlink and uplink packets. A single protocol entity of SDAP may be configured for each individual PDU session.

As shown in FIG. 2B, the protocol stack of the control plane of the Uu interface (between the UE 125 and the gNB 115) includes PHY layer (layer 1), and MAC, RLC and PDCP sublayers of layer 2 as described above and in addition, the RRC 206 sublayer and RRC 216 sublayer. The main services and functions of the RRC 206 sublayer and the RRC 216 sublayer over the Uu interface include: Broadcast of System Information related to AS and NAS; Paging initiated by 5GC or NG-RAN; Establishment, maintenance and release of an RRC connection between the UE and NG-RAN (including Addition, modification and release of carrier aggregation; and Addition, modification and release of Dual Connectivity in NR or between E-UTRA and NR); Security functions including key management; Establishment, configuration, maintenance and release of SRBs and DRBs; Mobility functions (including Handover and context transfer; UE cell selection and reselection and control of cell selection and reselection; and Inter-RAT mobility); QoS management functions; UE measurement reporting and control of the reporting; Detection of and recovery from radio link failure; and NAS message transfer to/from NAS from/to UE. The NAS 207 and NAS 227 layer is a control protocol (terminated in AMF on the network side) that performs the functions such as authentication, mobility management, security control, etc.

The sidelink specific services and functions of the RRC sublayer over the Uu interface include: Configuration of sidelink resource allocation via system information or dedicated signaling; Reporting of UE sidelink information; Measurement configuration and reporting related to sidelink; and Reporting of UE assistance information for SL traffic pattern(s).

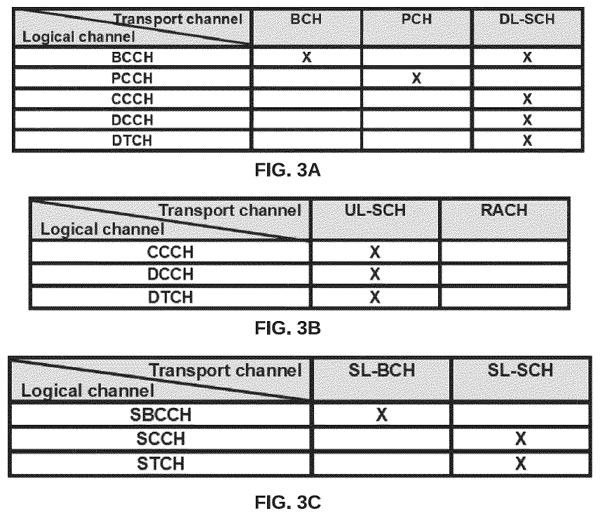

FIG. 3A, FIG. 3B and FIG. 3C show example mappings between logical channels and transport channels in downlink, uplink and sidelink, respectively, according to some aspects of some of various exemplary embodiments of the present disclosure. Different kinds of data transfer services may be offered by MAC. Each logical channel type may be defined by what type of information is transferred. Logical channels may be classified into two groups: Control Channels and Traffic Channels. Control channels may be used for the transfer of control plane information only. The Broadcast Control Channel (BCCH) is a downlink channel for broadcasting system control information. The Paging Control Channel (PCCH) is a downlink channel that carries paging messages. The Common Control Channel (CCCH) is channel for transmitting control information between UEs and network. This channel may be used for UEs having no RRC connection with the network. The Dedicated Control Channel (DCCH) is a point-to-point bi-directional channel that transmits dedicated control information between a UE and the network and may be used by UEs having an RRC connection. Traffic channels may be used for the transfer of user plane information only. The Dedicated Traffic Channel (DTCH) is a point-to-point channel, dedicated to one UE, for the transfer of user information. A DTCH may exist in both uplink and downlink. Sidelink Control Channel (SCCH) is a sidelink channel for transmitting control information (e.g., PC5-RRC and PC5-S messages) from one UE to other UE(s). Sidelink Traffic Channel (STCH) is a sidelink channel for transmitting user information from one UE to other UE(s). Sidelink Broadcast Control Channel (SBCCH) is a sidelink channel for broadcasting sidelink system information from one UE to other UE(s).

The downlink transport channel types include Broadcast Channel (BCH), Downlink Shared Channel (DL-SCH), and Paging Channel (PCH). The BCH may be characterized by: fixed, pre-defined transport format; and requirement to be broadcast in the entire coverage area of the cell, either as a single message or by beamforming different BCH instances. The DL-SCH may be characterized by: support for HARQ; support for dynamic link adaptation by varying the modulation, coding and transmit power; possibility to be broadcast in the entire cell; possibility to use beamforming; support for both dynamic and semi-static resource allocation; and the support for UE Discontinuous Reception (DRX) to enable UE power saving. The DL-SCH may be characterized by: support for HARQ; support for dynamic link adaptation by varying the modulation, coding and transmit power; possibility to be broadcast in the entire cell; possibility to use beamforming; support for both dynamic and semi-static resource allocation; support for UE discontinuous reception (DRX) to enable UE power saving. The PCH may be characterized by: support for UE discontinuous reception (DRX) to enable UE power saving (DRX cycle is indicated by the network to the UE); requirement to be broadcast in the entire coverage area of the cell, either as a single message or by beamforming different BCH instances; mapped to physical resources which can be used dynamically also for traffic/other control channels.

In downlink, the following connections between logical channels and transport channels may exist: BCCH may be mapped to BCH; BCCH may be mapped to DL-SCH; PCCH may be mapped to PCH; CCCH may be mapped to DL-SCH; DCCH may be mapped to DL-SCH; and DTCH may be mapped to DL-SCH.

The uplink transport channel types include Uplink Shared Channel (UL-SCH) and Random Access Channel(s) (RACH). The UL-SCH may be characterized by possibility to use beamforming; support for dynamic link adaptation by varying the transmit power and potentially modulation and coding; support for HARQ; support for both dynamic and semi-static resource allocation. The RACH may be characterized by limited control information; and collision risk.

In Uplink, the following connections between logical channels and transport channels may exist: CCCH may be mapped to UL-SCH; DCCH may be mapped to UL-SCH; and DTCH may be mapped to UL-SCH.

The sidelink transport channel types include: Sidelink broadcast channel (SL-BCH) and Sidelink shared channel (SL-SCH). The SL-BCH may be characterized by pre-defined transport format. The SL-SCH may be characterized by support for unicast transmission, groupcast transmission and broadcast transmission; support for both UE autonomous resource selection and scheduled resource allocation by NG-RAN; support for both dynamic and semi-static resource allocation when UE is allocated resources by the NG-RAN; support for HARQ; and support for dynamic link adaptation by varying the transmit power, modulation and coding.

In the sidelink, the following connections between logical channels and transport channels may exist: SCCH may be mapped to SL-SCH; STCH may be mapped to SL-SCH; and SBCCH may be mapped to SL-BCH.

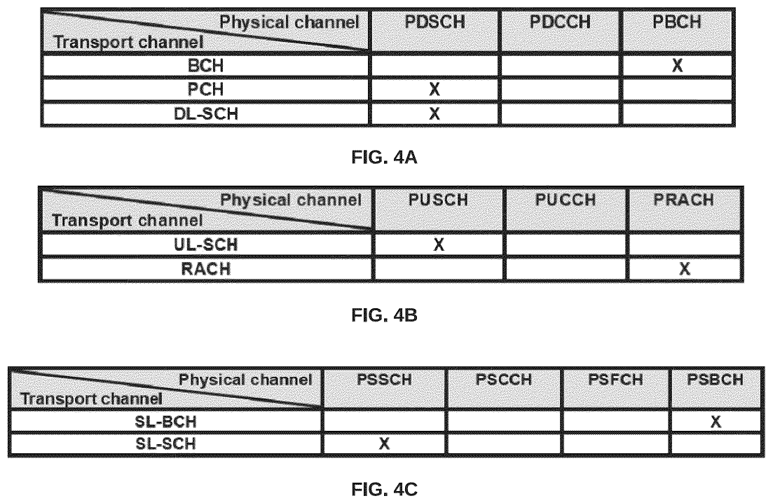

FIG. 4A, FIG. 4B and FIG. 4C show example mappings between transport channels and physical channels in downlink, uplink and sidelink, respectively, according to some aspects of some of various exemplary embodiments of the present disclosure. The physical channels in downlink include Physical Downlink Shared Channel (PDSCH), Physical Downlink Control Channel (PDCCH) and Physical Broadcast Channel (PBCH). The PCH and DL-SCH transport channels are mapped to the PDSCH. The BCH transport channel is mapped to the PBCH. A transport channel is not mapped to the PDCCH but Downlink Control Information (DCI) is transmitted via the PDCCH.

The physical channels in the uplink include Physical Uplink Shared Channel (PUSCH), Physical Uplink Control Channel (PUCCH) and Physical Random Access Channel (PRACH). The UL-SCH transport channel may be mapped to the PUSCH and the RACH transport channel may be mapped to the PRACH. A transport channel is not mapped to the PUCCH but Uplink Control Information (UCI) is transmitted via the PUCCH.

The physical channels in the sidelink include Physical Sidelink Shared Channel (PSSCH), Physical Sidelink Control Channel (PSCCH), Physical Sidelink Feedback Channel (PSFCH) and Physical Sidelink Broadcast Channel (PSBCH). The Physical Sidelink Control Channel (PSCCH) may indicate resource and other transmission parameters used by a UE for PSSCH. The Physical Sidelink Shared Channel (PSSCH) may transmit the TBs of data themselves, and control information for HARQ procedures and CSI feedback triggers, etc. At least 6 OFDM symbols within a slot may be used for PSSCH transmission. Physical Sidelink Feedback Channel (PSFCH) may carry the HARQ feedback over the sidelink from a UE which is an intended recipient of a PSSCH transmission to the UE which performed the transmission. PSFCH sequence may be transmitted in one PRB repeated over two OFDM symbols near the end of the sidelink resource in a slot. The SL-SCH transport channel may be mapped to the PSSCH. The SL-BCH may be mapped to PSBCH. No transport channel is mapped to the PSFCH but Sidelink Feedback Control Information (SFCI) may be mapped to the PSFCH. No transport channel is mapped to PSCCH but Sidelink Control Information (SCI) may be mapped to the PSCCH.

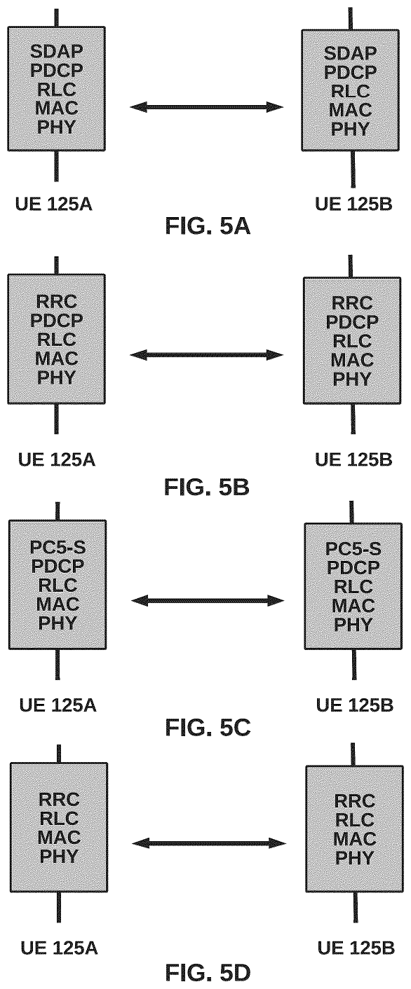

FIG. 5A, FIG. 5B, FIG. 5C and FIG. 5D show examples of radio protocol stacks for NR sidelink communication according to some aspects of some of various exemplary embodiments of the present disclosure. The AS protocol stack for user plane in the PC5 interface (i.e., for STCH) may consist of SDAP, PDCP, RLC and MAC sublayers, and the physical layer. The protocol stack of user plane is shown in FIG. 5A. The AS protocol stack for SBCCH in the PC5 interface may consist of RRC, RLC, MAC sublayers, and the physical layer as shown below in FIG. 5B. For support of PC5-S protocol, PC5-S is located on top of PDCP, RLC and MAC sublayers, and the physical layer in the control plane protocol stack for SCCH for PC5-S, as shown in FIG. 5C. The AS protocol stack for the control plane for SCCH for RRC in the PC5 interface consists of RRC, PDCP, RLC and MAC sublayers, and the physical layer. The protocol stack of control plane for SCCH for RRC is shown in FIG. 5D.

The Sidelink Radio Bearers (SLRBs) may be categorized into two groups: Sidelink Data Radio Bearers (SL DRB) for user plane data and Sidelink Signaling Radio Bearers (SL SRB) for control plane data. Separate SL SRBs using different SCCHs may be configured for PC5-RRC and PC5-S signaling, respectively.

The MAC sublayer may provide the following services and functions over the PC5 interface: Radio resource selection; Packet filtering; Priority handling between uplink and sidelink transmissions for a given UE; and Sidelink CSI reporting. With logical channel prioritization restrictions in MAC, only sidelink logical channels belonging to the same destination may be multiplexed into a MAC PDU for every unicast, groupcast and broadcast transmission which may be associated to the destination. For packet filtering, a SL-SCH MAC header including portions of both Source Layer-2 ID and a Destination Layer-2 ID may be added to a MAC PDU. The Logical Channel Identifier (LCID) included within a MAC subheader may uniquely identify a logical channel within the scope of the Source Layer-2 ID and Destination Layer-2 ID combination.

The services and functions of the RLC sublayer may be supported for sidelink. Both RLC Unacknowledged Mode (UM) and Acknowledged Mode (AM) may be used in unicast transmission while only UM may be used in groupcast or broadcast transmission. For UM, only unidirectional transmission may be supported for groupcast and broadcast.

The services and functions of the PDCP sublayer for the Uu interface may be supported for sidelink with some restrictions: Out-of-order delivery may be supported only for unicast transmission; and Duplication may not be supported over the PC5 interface.

The SDAP sublayer may provide the following service and function over the PC5 interface: Mapping between a QoS flow and a sidelink data radio bearer. There may be one SDAP entity per destination for one of unicast, groupcast and broadcast which is associated to the destination.

The RRC sublayer may provide the following services and functions over the PC5 interface: Transfer of a PC5-RRC message between peer UEs; Maintenance and release of a PC5-RRC connection between two UEs; and Detection of sidelink radio link failure for a PC5-RRC connection based on indication from MAC or RLC. A PC5-RRC connection may be a logical connection between two UEs for a pair of Source and Destination Layer-2 IDs which may be considered to be established after a corresponding PC5 unicast link is established. There may be one-to-one correspondence between the PC5-RRC connection and the PC5 unicast link. A UE may have multiple PC5-RRC connections with one or more UEs for different pairs of Source and Destination Layer-2 IDs. Separate PC5-RRC procedures and messages may be used for a UE to transfer UE capability and sidelink configuration including SL-DRB configuration to the peer UE. Both peer UEs may exchange their own UE capability and sidelink configuration using separate bi-directional procedures in both sidelink directions.

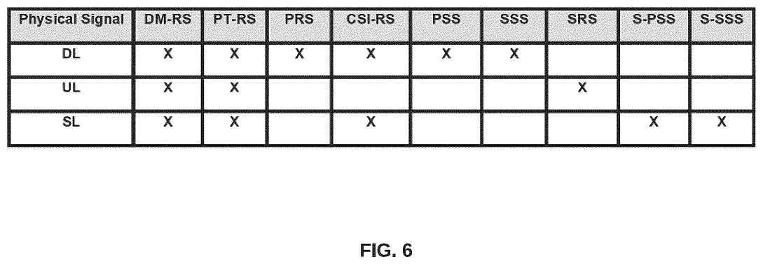

FIG. 6 shows example physical signals in downlink, uplink and sidelink according to some aspects of some of various exemplary embodiments of the present disclosure. The Demodulation Reference Signal (DM-RS) may be used in downlink, uplink and sidelink and may be used for channel estimation. DM-RS is a UE-specific reference signal and may be transmitted together with a physical channel in downlink, uplink or sidelink and may be used for channel estimation and coherent detection of the physical channel. The Phase Tracking Reference Signal (PT-RS) may be used in downlink, uplink and sidelink and may be used for tracking the phase and mitigating the performance loss due to phase noise. The PT-RS may be used mainly to estimate and minimize the effect of Common Phase Error (CPE) on system performance. Due to the phase noise properties, PT-RS signal may have a low density in the frequency domain and a high density in the time domain. PT-RS may occur in combination with DM-RS and when the network has configured PT-RS to be present. The Positioning Reference Signal (PRS) may be used in downlink for positioning using different positioning techniques. PRS may be used to measure the delays of the downlink transmissions by correlating the received signal from the base station with a local replica in the receiver. The Channel State Information Reference Signal (CSI-RS) may be used in downlink and sidelink. CSI-RS may be used for channel state estimation, Reference Signal Received Power (RSRP) measurement for mobility and beam management, time/frequency tracking for demodulation among other uses. CSI-RS may be configured UE-specifically but multiple users may share the same CSI-RS resource. The UE may determine CSI reports and transit them in the uplink to the base station using PUCCH or PUSCH. The CSI report may be carried in a sidelink MAC CE. The Primary Synchronization Signal (PSS) and the Secondary Synchronization Signal (SSS) may be used for radio fame synchronization. The PSS and SSS may be used for the cell search procedure during the initial attach or for mobility purposes. The Sounding Reference Signal (SRS) may be used in uplink for uplink channel estimation. Similar to CSI-RS, the SRS may serve as QCL reference for other physical channels such that they can be configured and transmitted quasi-collocated with SRS. The Sidelink PSS (S-PSS) and Sidelink SSS (S-SSS) may be used in sidelink for sidelink synchronization.

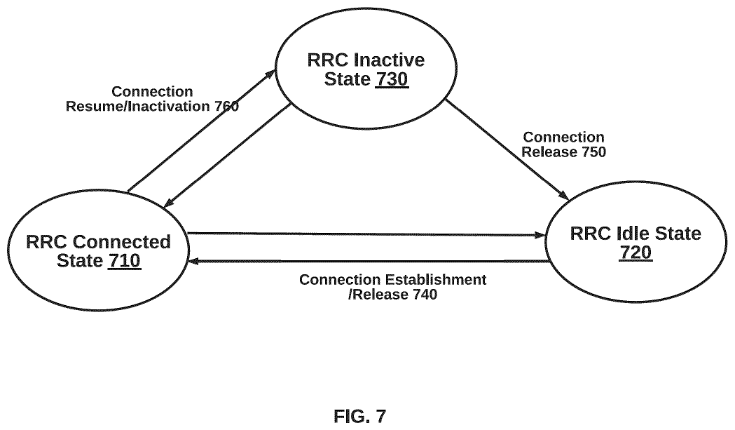

FIG. 7 shows examples of Radio Resource Control (RRC) states and transitioning between different RRC states according to some aspects of some of various exemplary embodiments of the present disclosure. A UE may be in one of three RRC states: RRC Connected State 710, RRC Idle State 720 and RRC Inactive state 730. After power up, the UE may be in RRC Idle state 720 and the UE may establish connection with the network using initial access and via an RRC connection establishment procedure to perform data transfer and/or to make/receive voice calls. Once RRC connection is established, the UE may be in RRC Connected State 710. The UE may transition from the RRC Idle state 720 to the RRC connected state 710 or from the RRC Connected State 710 to the RRC Idle state 720 using the RRC connection Establishment/Release procedures 740.

To reduce the signaling load and the latency resulting from frequent transitioning from the RRC Connected State 710 to the RRC Idle State 720 when the UE transmits frequent small data, the RRC Inactive State 730 may be used. In the RRC Inactive State 730, the AS context may be stored by both UE and gNB. This may result in faster state transition from the RRC Inactive State 730 to RRC Connected State 710. The UE may transition from the RRC Inactive State 730 to the RRC Connected State 710 or from the RRC Connected State 710 to the RRC Inactive State 730 using the RRC Connection Resume/Inactivation procedures 760. The UE may transition from the RRC Inactive State 730 to RRC Idle State 720 using an RRC Connection Release procedure 750.

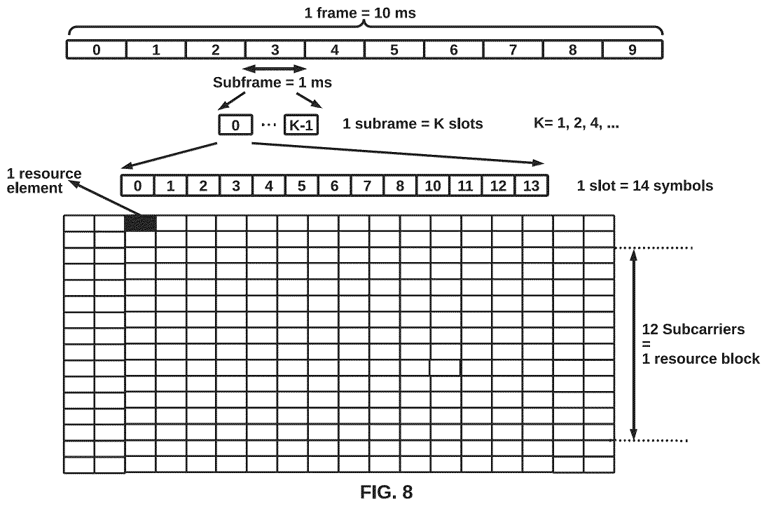

FIG. 8 shows example frame structure and physical resources according to some aspects of some of various exemplary embodiments of the present disclosure. The downlink or uplink or sidelink transmissions may be organized into frames with 10 ms duration, consisting of ten 1 ms subframes. Each subframe may consist of 1, 2, 4, . . . slots, wherein the number of slots per subframe may depend of the subcarrier spacing of the carrier on which the transmission takes place. The slot duration may be 14 symbols with Normal Cyclic Prefix (CP) and 12 symbols with Extended CP and may scale in time as a function of the used sub-carrier spacing so that there is an integer number of slots in a subframe. FIG. 8 shows a resource grid in time and frequency domain. Each element of the resource grid, comprising one symbol in time and one subcarrier in frequency, is referred to as a Resource Element (RE). A Resource Block (RB) may be defined as 12 consecutive subcarriers in the frequency domain.

In some examples and with non-slot-based scheduling, the transmission of a packet may occur over a portion of a slot, for example during 2, 4 or 7 OFDM symbols which may also be referred to as mini-slots. The mini-slots may be used for low latency applications such as URLLC and operation in unlicensed bands. In some embodiments, the mini-slots may also be used for fast flexible scheduling of services (e.g., pre-emption of URLLC over eMBB).

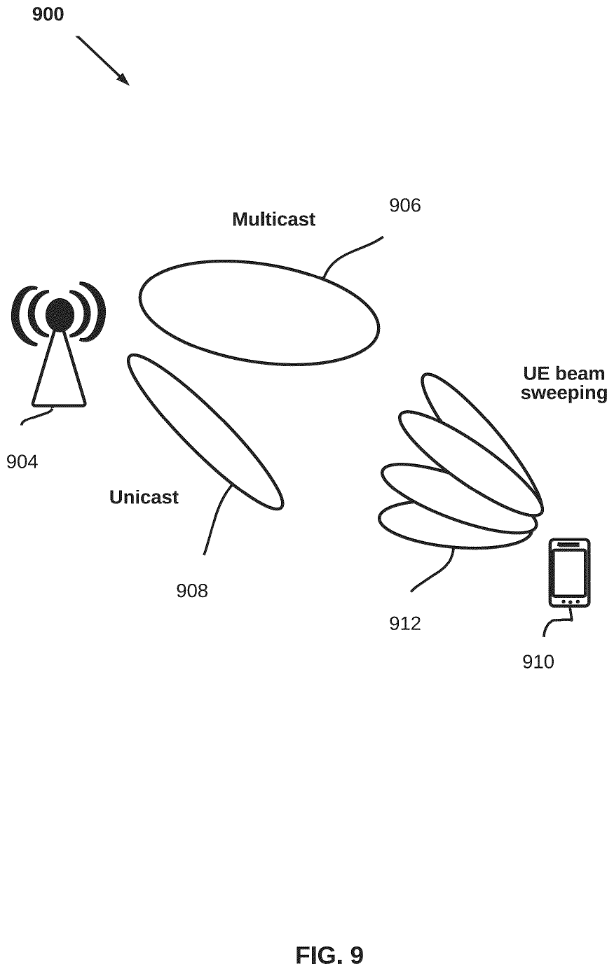

FIG. 9 shows example of a system for beam management and adaptation at a UE. As shown, UE 910 may receive unicast service via narrow beam 908, and Multicast Broadcast Service (MBS) via wide beam 906. The UE 910 may receive unicast service and MBS via its receive beam 912. In MBS, gNB 905 may broadcast data and control information to a group of UEs. The beam 906 can be a wide beam so as to cover transmission to a number of UEs which may spatially distributed in a cell. In unicast service, gNB 905 transmits data and control information only to UE 910, and therefore unicast beam 908 is a narrow beam steered toward UE 910.

The UE 910 may use its receive beam 912 to receive the multicast or unicast information. However, receive beam may not be matched to receive beams 906 and 908. In order to receive the multicast and unicast information from the gNB, the UE may change its receive beam direction to receive the strongest signals from the multicast beam 906 and unicast beam 908.

In some examples, the UE 910 may perform beam sweeping to find the best receive beam that achieve the strongest received signals for both beams 906 and 908. In this regard, the UE may measure the DL beams signals, and change its beam direction according to the measured signal. For example, the UE 910 may measure the DL beam signals via reference symbols embedded in received beams (e.g., CSI-RS). Once the UE 910 finds its desired receive beam direction, it may report this beam direction to the gNB 904. In some examples, gNB 904, may also change beam 908 (or beam 906) direction to improve the received signal strength according to the reported beam direction by the UE.

In some examples, the UE may have a set of M Rx beams for beam sweeping. The UE may sweep its beam each time, and performs beam measurement by measuring the received power of beams 906 and 908 from RS, e.g., CSI-RS, and may determine the receive beam quality based on the beam measurement. Then, the UE may determine the best receive beam that matches beam 906 and 908 based on the measured beam quality. For example, the UE may determine the best receive beam that have the highest received power for beams 906 and 908.

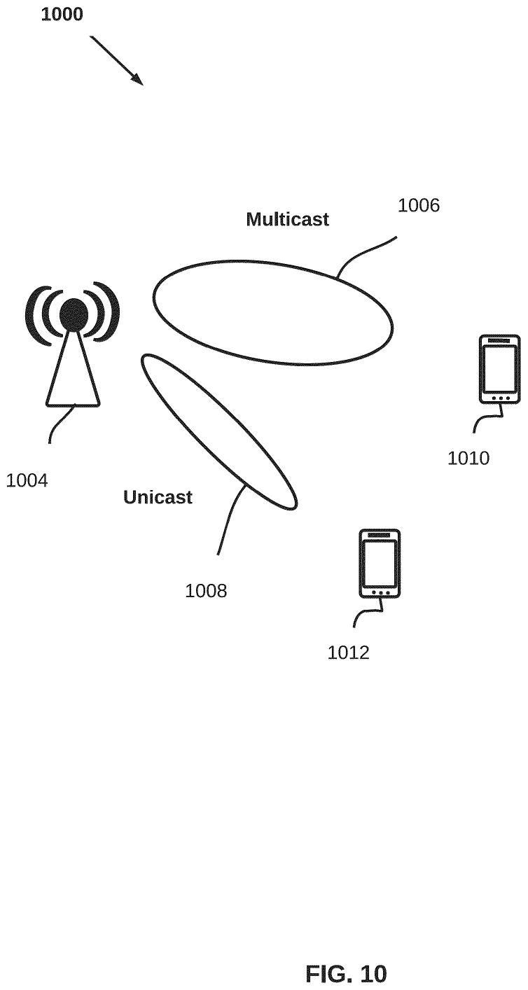

FIG. 10 shows example of a system for interreference management and a gNB. As shown, gNB 1004 may transmit unicast service to UE 1012 via narrow beam 1008, and MBS to UE 1010 via wide beam 1006. In MBS, gNB 1004 may broadcast data and control information to a group of UEs. The beam 906 can be a wide beam so as to cover transmission to a number of UEs which may spatially distributed in a cell. In unicast service, gNB 1004 may transmit data and control information only to UE 1012, and therefore unicast beam 1008 is a narrow beam steered toward UE 1012.

As illustrated, when a gNB simultaneously transmits multicast service to multiple UEs (e.g., UE 1010), and also transmits unicast service to a different UE (e.g., UE 1012), the multicast beam 1006 can cause interference on the unicast transmission to the unicast beam 1008. The interference of multicast beam 1006 can reduce the received power of beam 1012, and can therefore reduces link quality between UE 1012 and gNB 1004, which can reduce throughput and quality of service.

In some examples, UE 1012 may measure interference of multicast beam 1006 over unicast beam 1008 and reports the interference to gNB 1004. In some examples, UE 1012 may measure the received power of RS transmitted in beam 1006 and compute its interference on its DL beam 1008. In some examples, UE 1012 may report beam information including interference measurement of multicast beam 1006, and information indicating quality of its DL beam 1012. The measurement quantities may be in form of RSRP.

In some examples, UE 1012 may have a set of M Rx beams for beam sweeping. The UE may sweep its beam each time and performs beam measurement by measuring the receive power of beams 1006 and 1008 from RS, e.g., CSI-RS, and may compute the interference of beam 1006 over beam 1008. Then, the UE may determine the best receive beam that reduce the interreference of beam 1006 over beam 1008.

In some examples, based on the reported beam information form UE 1012, gNB may perform advance interference management techniques to mitigate the interference of multicast beam 1006 over unicast beam 1006. In some examples, the gNB may follow UE recommendation and may use the beam with the best reported beam for unicast transmission. In some examples, the gNB may change or refine the reported beam. The gNB may indicate the UE which beams to be used for data/control information transmission and the UE may use the corresponding proper receive beam for data reception.

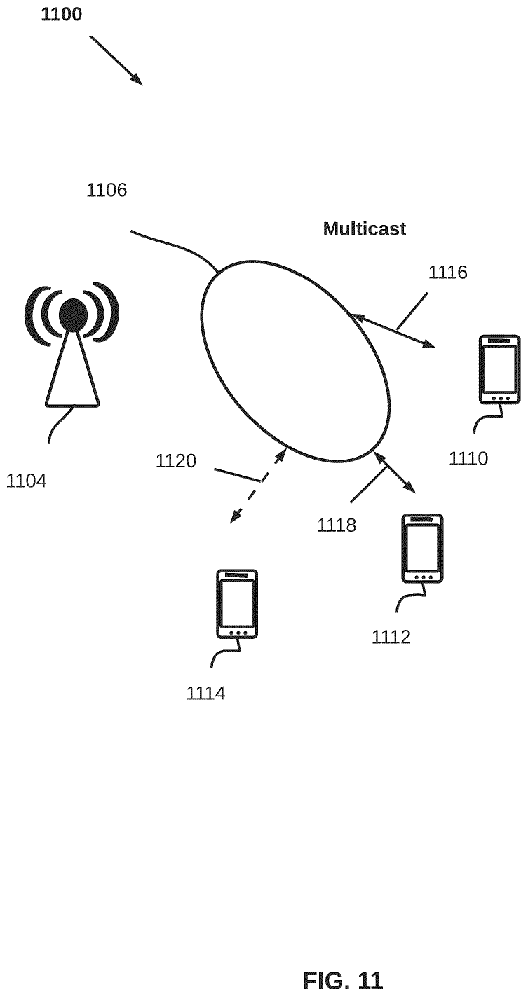

FIG. 11 shows example of a system for performing beam management scheme in MBS according to some aspects of some of various exemplary embodiments of the present disclosure. As shown, gNB 1104 transmits MBS to UE 1110 via link 1116, UE 1112 via link 1118, and UE 1114 via link 1120. The MBS beam 1106 transmits broadcast information to UEs 1110, 1112, and 1114. In MBS, gNB 1104 may broadcast data and control information to a group of UEs. The beam 1106 can be a wide beam so as to cover transmission to a number of UEs which may spatially distributed in a cell.

In system 1100, the link quality is determined by multiple links between gNB 1104 and UEs 1110, 1112, and 1114. Thus, if one of the UEs 1110, 1112, or 1114 experiences link failure (e.g., link 1120), and it requires retransmission, it will be very inefficient for gNB 1104 to perform re-transmission to all of UEs 1110, 1112, and 1114. In some examples the UE that experiences link failure (e.g., UE 1114) may indicate to gNB 1104 that it needs re-transmission, and gNB 1104 may schedule that UE (e.g., UE 1114) with unicast service.

As shown in FIG. 11, UE 1114 experiences link failure and required re-transmission from gNB 1104. In some examples, UE 1114 may indicate its desired beam direction and reports it to gNB 1104, and then gNB 1104 may schedule UE 1114 with unicast service in the reported beam direction by the UE 1114.

In some examples, UE 1114 may have a set of M Rx beams for beam sweeping. The UE may sweep its beam each time and performs beam measurement by measuring the receive power from RS, e.g., CSI-RS, and may determine best direction that provides the maximum receive power. In some examples, the UE may determine one or more candidate beam(s) that provide the strongest received power.

In some examples, UE 1114 may monitor the reference signals for beam failure detection and whether any beam failure triggering condition has been met. Once the beam failure event is declared and if one or more new candidate beam(s) are identified, the beam recovery procedure may be triggered. In some examples, a UE identifier and/or new candidate beam(s) may be indicated to the gNB as part of beam recovery request. The UE may monitor the corresponding control channel search space to receive the gNB response for beam failure recovery request, which may be transmitted by the new Tx unicast beam(s) identified by the UE. In some examples, a non-contention based random access may be used for carrying beam failure recovery request. In some examples, uplink control channel may be used for carrying beam failure recovery request for secondary cells in the case of carrier aggregation. The gNB and UE may use the newly identified beam(s) for subsequent communication.

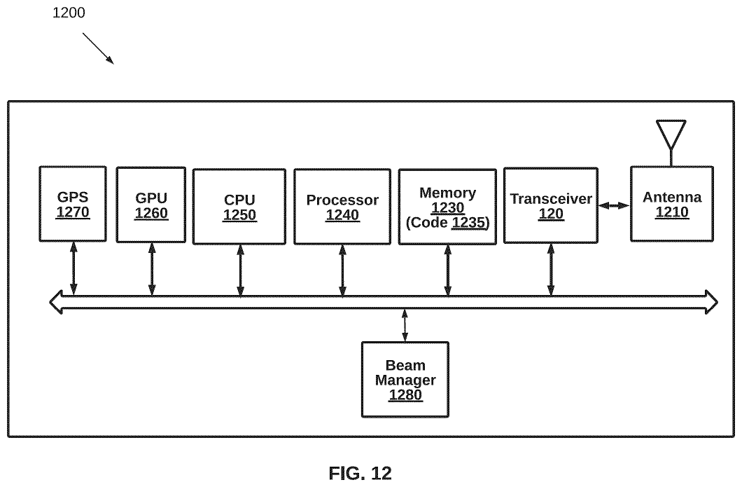

FIG. 12 shows example components of a user equipment (User Equipment) for transmission and/or reception according to some aspects of some of various exemplary embodiments of the present disclosure. All or a subset of blocks and functions in FIG. 12 may be in the user equipment 1200 and may be performed by the user equipment (e.g., 910, 1010, 1012, 1110, 1112, 1114). The Antenna 1210 may be used for transmission or reception of electromagnetic signals. The Antenna 1210 may comprise one or more antenna elements and may enable different input-output antenna configurations including Multiple-Input Multiple Output (MIMO) configuration, Multiple-Input Single-Output (MISO) configuration and Single-Input Multiple-Output (SIMO) configuration. In some embodiments, the Antenna 1210 may enable a massive MIMO configuration with tens or hundreds of antenna elements. The Antenna 1210 may enable other multi-antenna techniques such as beamforming. In some examples, depending on the UE 1200 capabilities or the type of UE 1200 (e.g., a low-complexity UE), the UE 1200 may support a single antenna only.

The transceiver 1220 may communicate bi-directionally, via the Antenna 1210, wireless links as described herein. For example, the transceiver 1220 may represent a wireless transceiver at the UE and may communicate bi-directionally with the wireless transceiver at the base station or vice versa. The transceiver 1220 may include a modem to modulate the packets and provide the modulated packets to the Antennas 1210 for transmission, and to demodulate packets received from the Antennas 1210.

The memory 1230 may include RAM and ROM. The memory 1230 may store computer-readable, computer-executable code 1235 including instructions that, when executed, cause the processor to perform various functions described herein. In some examples, the memory 1230 may contain, among other things, a Basic Input/output System (BIOS) which may control basic hardware or software operation such as the interaction with peripheral components or devices.

The processor 1240 may include a hardware device with processing capability (e.g., a general purpose processor, a DSP, a CPU, a microcontroller, an ASIC, an FPGA, a programmable logic device, a discrete gate or transistor logic component, a discrete hardware component, or any combination thereof). In some examples, the processor 1240 may be configured to operate a memory using a memory controller. In other examples, a memory controller may be integrated into the processor 1240. The processor 1240 may be configured to execute computer-readable instructions stored in a memory (e.g., the memory 1230) to cause the UE to perform various functions.

The Central Processing Unit (CPU) 1250 may perform basic arithmetic, logic, controlling, and Input/output (I/O) operations specified by the computer instructions in the Memory 1230. The UE 1200 may include additional peripheral components such as a graphics processing unit (GPU) 1260 and a Global Positioning System (GPS) 1270. The GPU 1260 is a specialized circuitry for rapid manipulation and altering of the Memory 1230 for accelerating the processing performance of the user equipment 1200. The GPS 1270 may be used for enabling location-based services or other services for example based on geographical position of the user equipment 1200.

The beam manager 1280, may perform a mechanism to perform beam and interference management with reference to systems 900, 1000, 1100 described in FIGS. 9, 10,11. The beam manager 1280 may measure received power from multicast and unicast beam transmitted from a gNB and calculated the interference between multicast and unicast beams. Further, the UE may beam manager 1280 may determine its desired DL unicast beam and indicate to the gNB. Additionally, the block 1280 includes mechanisms to allow the UE to perform beam sweeping, as was described previously. Additionally, the beam manager 1280, may include mechanisms to detect beam failure, and declare beam failure to the gNB.

In some examples, a UE 1200 may perform a set of physical layer/medium access control procedures to determine a set of beams candidates e.g., a beam used at transmit-receive point for the gNB side paired with a beam used at UE. The beam pair links may be used for unicast downlink and uplink transmission/reception. The beam management procedures may include one or more of: a beam sweeping process, a beam measurement process, a beam reporting process, a beam determination process, a beam maintenance process, and a beam recovery process. For example, beam sweeping process may be used for determining receive beam, with beams transmitted and/or received during a time interval in a predetermined way. The beam measurement process may be used by the gNB or the UE to measure characteristics of received beamformed (BF) signals. The beam reporting process may be used by the UE to report information of BF signal(s) based on beam measurement. The beam determination process may be used by the gNB or UE to select the Tx/Rx beam(s). The beam maintenance process may be used by the gNB or UE to maintain the candidate beams by beam tracking or refinement to adapt to the channel changes due to UE movement or blockage. The beam recovery process may be used by the UE to identify new candidate beam(s) after detecting beam failure and subsequently indicate the BS of beam recovery request with information of indicating the new candidate beam(s).

In some examples, beam management may be performed in UL and/or DL directions. When good channel reciprocity is available (e.g., in time division duplex (TDD) systems), beam management of one direction may be based on another direction, e.g., UL beam management may perform well based on the results of DL beam management. In some examples, beam correspondence may be used based on uplink-downlink reciprocity of beamformed channel, for example UL Tx/Rx beam(s) may be determined based on beam measurement of DL beamformed reference signals (RSs).

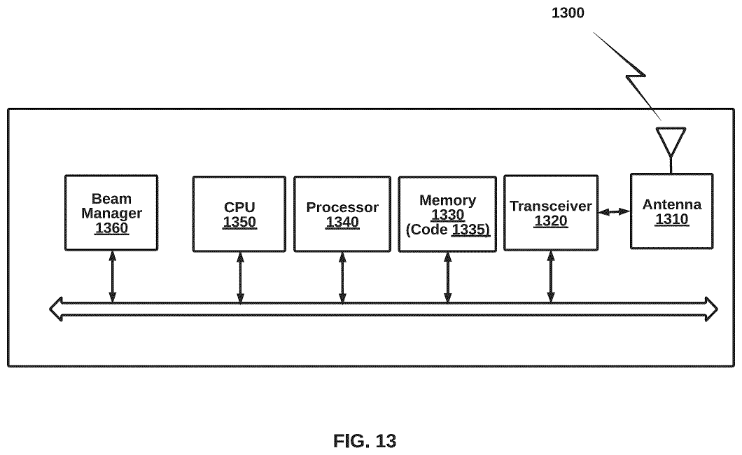

FIG. 23 shows example components of a base station 1300 (e.g., gNB) for transmission and/or reception according to some aspects of some of various exemplary embodiments of the present disclosure. All or a subset of blocks and functions in FIG. 13 may be in the base station 1300 and may be performed by the base station 1300 (e.g., gNB 904, 1004, 1104). The Antenna 1310 may be used for transmission or reception of electromagnetic signals. The Antenna 1310 may comprise one or more antenna elements and may enable different input-output antenna configurations including Multiple-Input Multiple Output (MIMO) configuration, Multiple-Input Single-Output (MISO) configuration and Single-Input Multiple-Output (SIMO) configuration. In some embodiments, the Antenna 1310 may enable a massive MIMO configuration with tens or hundreds of antenna elements. The Antenna 1310 may enable other multi-antenna techniques such as beamforming. In some examples and depending on the base station 1300 capabilities or the type of base station 1300, the base station 13000 may support a single antenna only.

The transceiver 1320 may communicate bi-directionally, via the Antenna 1310, wireless links as described herein. For example, the transceiver 1320 may represent a wireless transceiver at the UE and may communicate bi-directionally with the wireless transceiver at the base station or vice versa. The transceiver 1320 may include a modem to modulate the packets and provide the modulated packets to the Antennas 1310 for transmission, and to demodulate packets received from the Antennas 1310.

The memory 1330 may include RAM and ROM. The memory 1330 may store computer-readable, computer-executable code 1335 including instructions that, when executed, cause the processor to perform various functions described herein. In some examples, the memory 1330 may contain, among other things, a Basic Input/output System (BIOS) which may control basic hardware or software operation such as the interaction with peripheral components or devices.

The processor 1340 may include a hardware device with processing capability (e.g., a general purpose processor, a DSP, a CPU, a microcontroller, an ASIC, an FPGA, a programmable logic device, a discrete gate or transistor logic component, a discrete hardware component, or any combination thereof). In some examples, the processor 1340 may be configured to operate a memory using a memory controller. In other examples, a memory controller may be integrated into the processor 1340. The processor 1340 may be configured to execute computer-readable instructions stored in a memory (e.g., the memory 1330) to cause the base station 1300 to perform various functions.

The Central Processing Unit (CPU) 1350 may perform basic arithmetic, logic, controlling, and Input/output (I/O) operations specified by the computer instructions in the Memory 1330.

The beam manager 1360 may receive the beam report from a UE (e.g., UE 1200) indicating the UE desired beam candidates. The beam manager 1300 may follow the UE recommendation and adapt its unicast DL beam according to the UE indicate candidates.

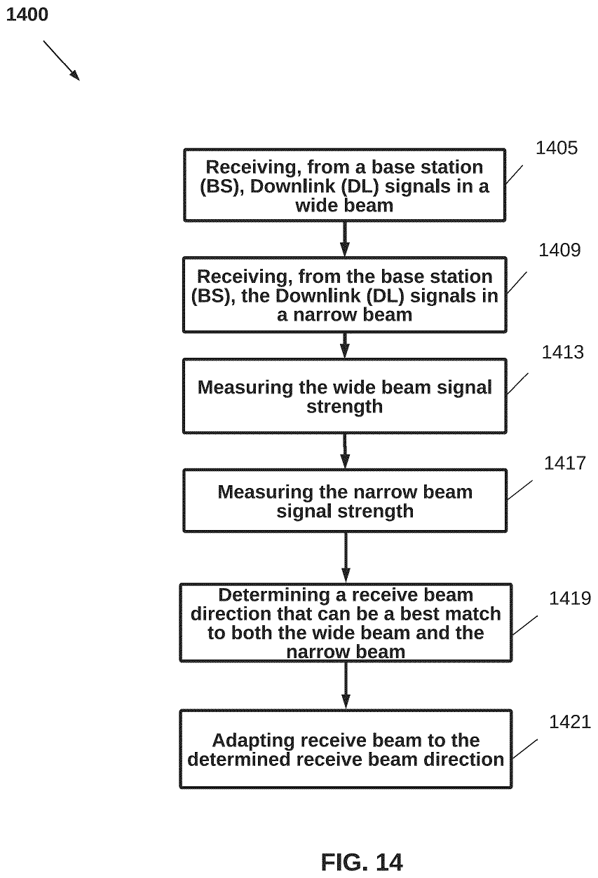

FIG. 14 is a flow diagram of a method 1400 for a UE performing management while receiving both unicast and MBS according to according to some aspects of the present disclosure. The method 1400 is implemented by a UE (e.g., UE 1200). The steps of method 1400 can be executed by computing devices (e.g., a processor, processing circuit, and/or other components) of the UE. As illustrated, the method 1400 may include additional steps before, after, and in between the enumerated steps.

At step 1405, the UE receives from a BS, MBS. The MBS is transmitted via a wide beam as previously described and is transmitted to a group of UEs. The MBS beam may include RS (e.g., CRI-RS) placed in time and frequency to enable the UE to measure the beam received power.

At step 1409, the UE receives form the BS unicast service. The unicast service is transmitted only to the UE via a narrow beam steered towards the UE as previously described. The unicast beam may include RS (e.g., CRI-RS) placed in time and frequency to enable the UE to measure the beam received power.

At step 1413, the UE measures the MBS beam power by computing RS power, and compute beam parameters (e.g., RSRP, RSRQ).

At step 1417, the UE may measure the unicast beam power by computing RS power, and compute beam parameters (e.g., RSRP, RSRQ).

At step 1419, the UE determines a receive beam that can be a best match to both MBS and unicast beams. The best match beam may provide the highest received power for the MBS beam and unicast beam. In some examples, the UE may perform a beam sweeping process to determine the best match beam. The UE may report the best match beam to the BS, and the BS may follow UE recommendation and change its unicast beam according to the UE recommendation.

At step 1421, the UE adapts its receive beam to best match beam determined in the previous step. The UE may perform a maintenance process to measure the MBS and unicast beams and adapt its receive beam continuously as the measured beam powers changes.

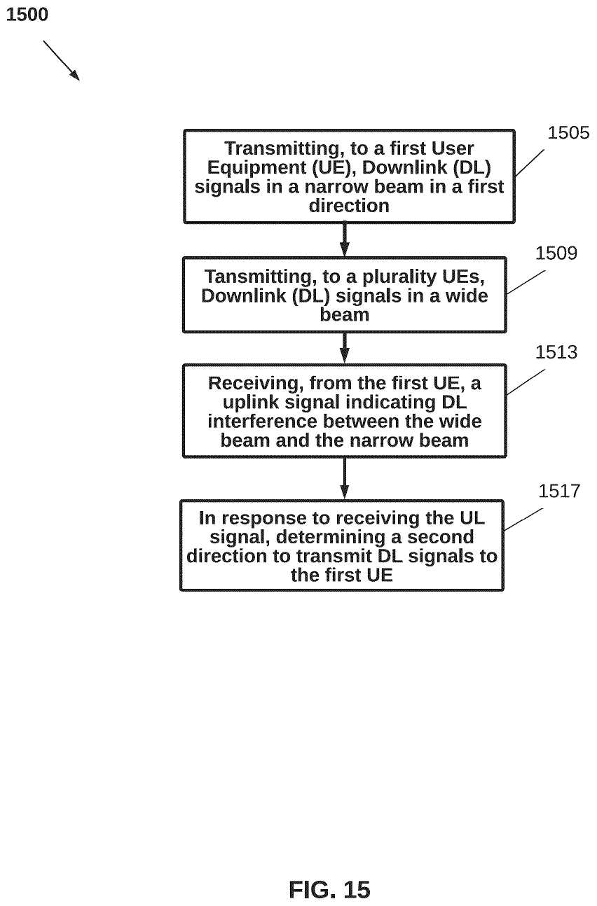

FIG. 15 is a flow diagram of a method 1500 for a BS performing interference management according to according to some aspects of the present disclosure. The method 1500 is implemented by a BS (e.g., BS 1300). The steps of method 1500 can be executed by computing devices (e.g., a processor, processing circuit, and/or other components) of the UE. As illustrated, the method 1500 may include additional steps before, after, and in between the enumerated steps.

At step 1505, the BS transmits unicast service to a first UE. The unicast signals are transmitted to the first UE in a narrow beam steered towards the UE in a first direction. The unicast beam is dedicated to the first UE, and the other UEs connected to the BS does not receive the unicast beam. The unicast beam may include RS to enable the first UE to measure the unicast beam power.

At step 1509, the BS transmits MBS to a group of UEs. The MBS signals are transmitted to the group of UEs in a wide beam broadcasted to group of the UE. The MBS beam may include RS to enable the group of the UE to measure the MBS beam power.

At step, the BS may receive a report from the first UE indicating the interference between the unicast and MBS beams. As described previously, the first UE may compute the interference between the unicast and MBS beams by measuring RS embedded in the unicast and MBS beams. The report may include one or more candidates of the first UE's desired received beams.

At step 1517, the base station transmits unicast service to the first UE in a second direction. The BS may select the second direction from the candidate beams reported by the first UE. The BS station may dynamically change the unicast direction according to updated report received from the first UE due to interference limitation changes in the cell.

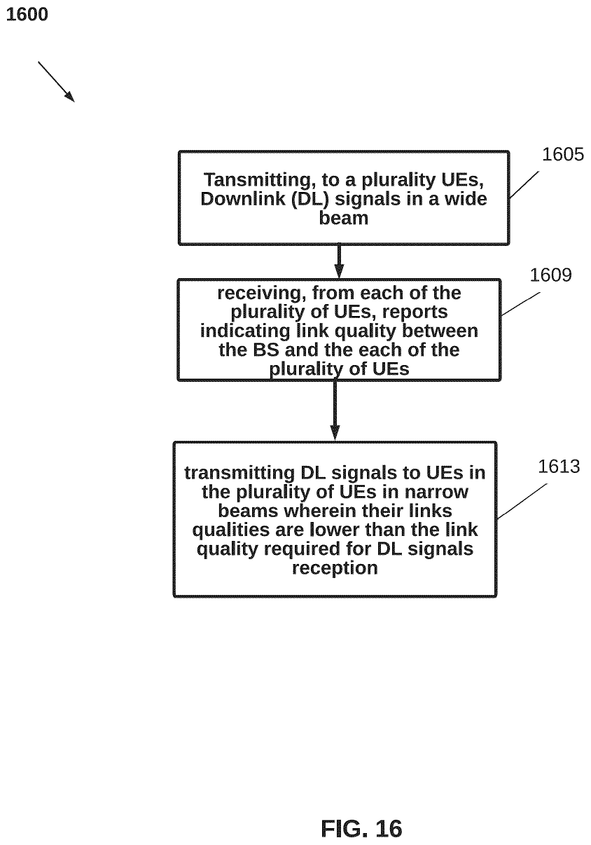

FIG. 16 is a flow diagram of a method 1600 for a BS performing beam management according to according to some aspects of the present disclosure. The method 1600 is implemented by a BS (e.g., BS 1300). The steps of method 1600 can be executed by computing devices (e.g., a processor, processing circuit, and/or other components) of the UE. As illustrated, the method 1600 may include additional steps before, after, and in between the enumerated steps.

At step 1605, the BS transmits to a group of UEs MBS. The MBS is broadcasted in a wide beam to the group of the UEs. The MBS beam may include RS so as the UEs can measure the beam received power.

At step 1609, the BS receives reports from each UEs in the group indicating the link quality between the BS and each of the UEs. The BS may determine the link failures based on the received report. In some examples, the UEs may indicate to the BS their desired received beam as well. If the BS determined any link failures, it proceed to the next step.

At step 1613, the BS schedules those UEs which were determined to have link failures with unicast services and transmits DL signals to those UEs in unicast beams. In some examples, the BS may follow the UEs report, and schedules the UEs in their indicated beams.

The exemplary blocks and modules described in this disclosure with respect to the various example embodiments may be implemented or performed with a general-purpose processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. Examples of the general-purpose processor include but are not limited to a microprocessor, any conventional processor, a controller, a microcontroller, or a state machine. In some examples, a processor may be implemented using a combination of devices (e.g., a combination of a DSP and a microprocessor, multiple microprocessors, one or more microprocessors in conjunction with a DSP core, or any other such configuration).

The functions described in this disclosure may be implemented in hardware, software executed by a processor, firmware, or any combination thereof. Instructions or code may be stored or transmitted on a computer-readable medium for implementation of the functions. Other examples for implementation of the functions disclosed herein are also within the scope of this disclosure. Implementation of the functions may be via physically co-located or distributed elements (e.g., at various positions), including being distributed such that portions of functions are implemented at different physical locations.

Computer-readable media includes but is not limited to non-transitory computer storage media. A non-transitory storage medium may be accessed by a general purpose or special purpose computer. Examples of non-transitory storage media include, but are not limited to, random access memory (RAM), read-only memory (ROM), electrically erasable programmable ROM (EEPROM), flash memory, compact disk (CD) ROM or other optical disk storage, magnetic disk storage or other magnetic storage devices, etc. A non-transitory medium may be used to carry or store desired program code means (e.g., instructions and/or data structures) and may be accessed by a general-purpose or special-purpose computer, or a general-purpose or special-purpose processor. In some examples, the software/program code may be transmitted from a remote source (e.g., a website, a server, etc.) using a coaxial cable, fiber optic cable, twisted pair, digital subscriber line (DSL), or wireless technologies such as infrared, radio, and microwave. In such examples, the coaxial cable, fiber optic cable, twisted pair, DSL, or wireless technologies such as infrared, radio, and microwave are within the scope of the definition of medium. Combinations of the above examples are also within the scope of computer-readable media.

As used in this disclosure, use of the term “or” in a list of items indicates an inclusive list. The list of items may be prefaced by a phrase such as “at least one of” or “one or more of”. For example, a list of at least one of A, B, or C includes A or B or C or AB (i.e., A and B) or AC or BC or ABC (i.e., A and B and C). Also, as used in this disclosure, prefacing a list of conditions with the phrase “based on” shall not be construed as “based only on” the set of conditions and rather shall be construed as “based at least in part on” the set of conditions. For example, an outcome described as “based on condition A” may be based on both a condition A and a condition B without departing from the scope of this disclosure.

In this specification the terms “comprise”, “include” or “contain” may be used interchangeably and have the same meaning and are to be construed as inclusive and open-ending. The terms “comprise”, “include” or “contain” may be used before a list of elements and indicate that at least all of the listed elements within the list exist but other elements that are not in the list may also be present. For example, if A comprises B and C, both {B, C} and {B, C, D} are within the scope of A.

The present disclosure, in connection with the accompanied drawings, describes example configurations that are not representative of all the examples that may be implemented or all configurations that are within the scope of this disclosure. The term “exemplary” should not be construed as “preferred” or “advantageous compared to other examples” but rather “an illustration, an instance or an example.” By reading this disclosure, including the description of the embodiments and the drawings, it will be appreciated by a person of ordinary skills in the art that the technology disclosed herein may be implemented using alternative embodiments. The person of ordinary skill in the art would appreciate that the embodiments, or certain features of the embodiments described herein, may be combined to arrive at yet other embodiments for practicing the technology described in the present disclosure. Thus, the disclosure is not limited to the examples and designs described herein but is to be accorded the broadest scope consistent with the principles and novel features disclosed herein.

1. A method of beam adaptation at a user equipment (UE), comprising the steps of:
receiving, from a base station (BS), Downlink (DL) signals in a wide beam;
receiving, from the base station (BS), the Downlink (DL) signals in a narrow beam;
measuring the wide beam signal strength;
measuring the narrow beam signal strength;
determining a receive beam direction that can be a best match to both the wide beam and the narrow beam; and
adapting receive beam to the determined receive beam direction.

2. The method of claim 1, wherein the wide beam indicates a Multicast Broadcast Service (MBS) transmission from the BS to a plurality of user equipments (UEs).

3. The method of claim 1, wherein the narrow beam indicates a unicast service transmission from the BS to the user equipment (UE).

4. The method of claim 1, wherein determining the receive beam direction includes:
changing the receive beam direction to a new beam direction; and
measuring received signal strength from the base station (BS) in both the wide beam and the narrow beam.

5. The method of claim 1, further comprising:
measuring a plurality of downlink (DLs) beams transmitted from the base station (BS); and
reporting the best beam direction in the plurality of DL beams that can be a match to the wide beam and the narrow beam to the BS.

6. The method of claim 1, wherein measuring the wide beam signal strength or the narrow beam signal strength includes measuring Reference Signal Received Power (RSRP) and Reference Signal Received Quality (RSRQ) of the narrow beam or the wide beam.

7. The method of claim 5, further comprising:
receiving, from the base station (BS), the downlink (DL) signals in the best beam direction reported by the user equipment (UE).

8. A method of interference management at a Base Station (BS), comprising the steps of:
transmitting, to a first User Equipment (UE), Downlink (DL) signals in a narrow beam in a first direction;
transmitting, to a plurality UEs, Downlink (DL) signals in a wide beam;
receiving, from the first UE, an Uplink signal indicating DL interference between the wide beam and the narrow beam; and
in response to receiving the UL signal, determining a second direction to transmit DL signals to the first UE.

9. The method of claim 8, wherein the wide beam indicates a Multicast Broadcast Service (MBS) transmitted from the BS to a plurality of user equipment (UEs).

10. The method of claim 8, wherein the narrow beam indicates a unicast service transmitted from the BS to the first user equipment (UE).

11. The method of claim 8, wherein the determining the second direction includes determining the second direction such as transmitting the downlink (DL) signals in the second direction reduces the interference of the wide beam over the narrow beam.

12. A method of beam management at a Base Station (BS), comprising the steps of:
transmitting, to a plurality user equipments (UEs), downlink (DL) signals in a wide beam;
receiving, from each of the plurality of UEs, reports indicating link quality between the BS and the each of the plurality of UEs; and
transmitting DL signals to UEs in the plurality of UEs in narrow beams wherein their links qualities are lower than the link quality required for DL signals reception.

13. The method of claim 12, wherein the wide beam indicates a Multicast Broadcast Service (MBS) transmitted from the base station (BS) to the plurality of user equipments (UEs).

14. The method of claim 12, wherein the step of transmitting downlink (DL) signals to the user equipments (UEs) in the plurality of UEs in the narrow beams wherein their links qualities are lower than the link quality required for DL signals reception includes transmitting DL signals to the UEs in unicast services.

15. A user equipment (UE), comprising:
a transceiver configured to:
receive, from a base station (BS), Downlink (DL) signals in a wide beam;
receive, from the base station (BS), the Downlink (DL) signals in a narrow beam;
measure the wide beam signal strength; and
measure the narrow beam signal strength; and
a processor in communication with the transceiver and configured to:
determine a receive beam direction that can be a best match to both the wide beam and the narrow beam; and
adapt receive beam to the determined receive beam direction.

16. The user equipment (UE) of claim 15, wherein the transceiver is further configured to receive Multicast Broadcast Service (MBS) from the base station (BS) in the wide beam.

17. The user equipment (UE) of claim 15, wherein the transceiver is further configured to receive unicast service from the base station (BS) in the narrow beam.

18. The user equipment (UE) of claim 15, wherein the processor is further configured to:
change the receive beam to a new beam direction; and
measure received signal strength from the base station (BS) in both the wide beam and the narrow beam.

19. The user equipment (UE) of claim 15, wherein the processor is further configured to:
measure a plurality of downlink (DL) beams transmitted from the base station (BS); and
report a best beam direction in the plurality of DL beams that can be a match to the wide beam and the narrow beam to the BS.

20. The user equipment (UE) of claim 19, wherein the processor is further configured to:
receive from the base station (BS), the downlink (DL) signals in the best beam direction reported by the user equipment (UE).
